(19) United States
(12) Patent Application Publication
(10) Pub. No.: US 2026/0160404 A1
(43) Pub. Date: Jun. 11, 2026

(54) MULTI-LAYER DISPLAY ELEMENT FOR SELECTIVE DISPLAY

(71) Applicant: Tesla, Inc., Austin, TX (US)

(72) Inventors: Bharath Swaminathan, Livermore, CA (US); Aneesh Kaliyanda, San Jose, CA (US); Shakeel Theodore, Fremont, CA (US); Richard Zhovner, Auburn Hills, MI (US)

(21) Appl. No.: 18/708,416

(22) PCT Filed: Nov. 4, 2022
(86) PCT No.: PCT/US2022/048996

§ 371 Date: May 8, 2024

Related U.S. Application Data
(60) Provisional application No. 63/277,068, filed on Nov. 8, 2021.

(51) Int. Cl. F21V 11/08; B60K 35/22

(52) U.S. Cl. CPC F21V 11/08; B60K 35/22

(57) ABSTRACT

A multi-layer display element with a matte finish surface capable of hiding the outline of a graphic until a light illuminates the graphic from behind the display.

### INCORPORATION BY REFERENCE TO ANY PRIORITY APPLICATIONS

Any and all applications for which a foreign or domestic priority claim is identified in the Application Data Sheet or Request as filed with the present application are hereby incorporated by reference under 37 CFR 1.57, and Rules 4.18 and 20.6, including U.S. Provisional App. No. 63/277,068, filed Nov. 8, 2021.

### BACKGROUND

As a vehicular design element, one or more display elements may be presented during operation, use or occupancy of a vehicle. Some display elements may be continuously displayed or presented. Other display elements may be associated with additional components, such as light sources, that provides for control of the presentation of the display elements.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Some embodiments of the present disclosure relate to multi-layer display element including: a first layer including an optical plastic, a matte grain or varnish, or a graphical mask; a second layer including an optical plastic, matte grain or varnish, or a graphical mask; a third layer including an optical plastic, matte grain or varnish, or a graphical mask; and at least one interactive component configured to provide a light source. Some embodiments of the present disclosure relate to multi-layer display element including: a first layer including an optical plastic; a second layer including a matte grain or varnish, wherein the second layer is disposed onto the first layer; a third layer including a graphical mask, wherein the third layer is disposed onto the first layer, and wherein the second layer and the third layer are arranged on opposite surfaces of the first layer; and at least one interactive component configured to provide a light source.

In some embodiments, the multi-layer display element further includes a fourth layer includes a touch screen interface. In still further embodiments, the multi-layer display element further includes at least one haptic feedback actuator device. In some embodiments, the haptic feedback actuator device includes a plurality of haptic feedback actuators. In some embodiments, the at least one interactive component configured to provide a light source includes a plurality of light sources, wherein the light sources are independently operable to generate selective light or a light flux or spectrum.

In some embodiments, the first layer corresponds to an optical plastic, the second layer corresponds to a matte grain or varnish, and the third layer corresponds to a graphical mask. In some embodiments, the first layer corresponds to an optical plastic, the second layer corresponds to a graphical mask, and the third layer corresponds to a matte grain or varnish. In some embodiments, the first layer corresponds to a matte grain or varnish, the second layer corresponds to an optical plastic, and the third layer corresponds to a graphical mask. In some embodiments, the first layer corresponds to a matte grain or varnish, the second layer corresponds to a graphical mask, and the third layer corresponds to an optical plastic. In some embodiments, the first layer corresponds to a graphical mask, the second layer corresponds to an optical plastic, and the third layer corresponds to a matte grain or varnish. In some embodiments, the first layer corresponds to a graphical mask, the second layer corresponds to a matte grain or varnish, and the third layer corresponds to an optical plastic.

In some embodiments, the first layer corresponds to an optical plastic, the second layer corresponds to a matte grain or varnish, and the third layer corresponds to a graphical mask. In some embodiments, the first layer corresponds to a matte grain or varnish. In some embodiments, the first layer corresponds to a graphical mask.

Some embodiments of the present disclosure relate to a multi-layer display element including an A-surface, a B-surface, and at least one interactive component configured to provide a light source, wherein the A-surface is the outer surface of the multi-layer display element, the B-surface is the inner surface of the multi-layer display element, and wherein the A-surface and the B-surface are on opposite sides of the multi-layer display element, wherein the A-surface is a matte grain or varnish, and wherein the B-surface is configured to control the path of the light source. In some embodiments, the B-surface includes a graphical mask. In some embodiments, the multi-layer display element further includes a graphical mask. In some embodiments, the multi-layer display element further includes a touch screen interface. In further embodiments, the multi-layer display element further includes at least one haptic feedback actuator device. In yet further embodiments, haptic feedback actuator device includes a plurality of haptic feedback actuators. In some embodiments, the at least one interactive component configured to provide a light source includes a plurality of light sources, wherein the light sources are independently operable to generate selective light or a light flux or spectrum.

Some embodiments of the present disclosure relate to a method of producing a multi-layer display element including: molding an optical-grade resin into a plastic comprising an A-surface and a B-surface; masking the B-surface of the plastic; and coating the A-surface of the plastic with a matte clearcoat varnish. In some embodiments, the plastic has a grained matte finish after being molded. In some embodiments, the at least one interactive component configured to provide a light source includes a plurality of light sources, wherein the light sources are independently operable to generate selective light or a light flux or spectrum,

Some embodiments of the present disclosure relate to a method of producing a multi-layer display element including: molding an optical-grade resin into a plastic comprising an A-surface and a B-surface; and masking the B-surface of the plastic. In some embodiments, the plastic has a grained matte finish after being molded. In some embodiments, the method of producing a multi-layer display element further includes coating the A-surface of the plastic with a matte clearcoat varnish.

Some embodiments of the present disclosure relate to a method of producing a multi-layer display element including: molding an optical-grade resin into a plastic comprising an A-surface and a B-surface, wherein the plastic has a grained matte finish; and masking the B-surface of the plastic.

In some embodiments, the masking of the B-surface of the plastic includes laser-etching a light-blocking paint onto the B-surface of the plastic. In other embodiments, the masking of the B-surface of the plastic includes over-molding the plastic with an opaque plastic. In some embodiments, the multi-layer display element is capable of hiding an outline of a graphic. In further embodiments, the masking of the B-surface of the plastic is disposed in the negative shape of the graphic.

In any embodiment of the present disclosure, the multi-layer display element further includes a display panel. In some embodiments, the multi-layer display element is capable of allowing a light source to pass from the B-surface of the plastic through the A-surface of the plastic. In some embodiments, the multi-layer display element is capable of allowing a signal to pass from the A-surface of the plastic through the B-surface of the plastic.

### BRIEF DESCRIPTION OF THE DRAWINGS

FIG. 1 provides a cross-section diagram of a matte finished optical plastic with a graphic mask, a light source, and light source controller.

FIG. 2 provides a cross-section diagram of a matte finished optical plastic with a graphic mask and touch screen interface, a light source, haptic feedback actuator and drivers, and controllers.

FIG. 3A illustrates the light reflective properties of the optical plastic when the graphic light is off.

FIG. 3B illustrates the light emission through the masked optical plastic when the graphic light is on.

FIG. 4 provides a cross-section diagram of a matte finished optical plastic which the light source functions as a mask.

FIG. 5 provides an example the matte finished optical plastic with hidden graphics when the light is off and with lit graphics when the light is on.

FIG. 6 provides a cross-section diagram of a matte finished optical plastic which allows a signal to pass from the A-surface of the plastic through the B-surface of the plastic.

FIG. 7 provides a cross-section diagram of a matte finished optical plastic which allows a light source to pass from the B-surface of the plastic through the A-surface of the plastic, and a signal to pass from the A-surface of the plastic through the B-surface of the plastic.

FIG. 8 provides a flow diagram of a method of producing a multi-layer display element, according to one embodiment of the present disclosure.

FIG. 9 provides a flow diagram of a method of producing a multi-layer display element, according to one embodiment of the present disclosure.

### DETAILED DESCRIPTION

One or more aspects of the present disclosure relates to systems and methods for selectively displaying vehicle display elements. More specifically, aspects of the present application correspond to a multi-layered display element and lighting source that is configured for the selective display of a graphic embedded in the display element responsive to activation of the light source. The multi-layer display element can provide a graphical display or illumination without the light source or graphic being viewable. Masking methods for such plastics are also disclosed.

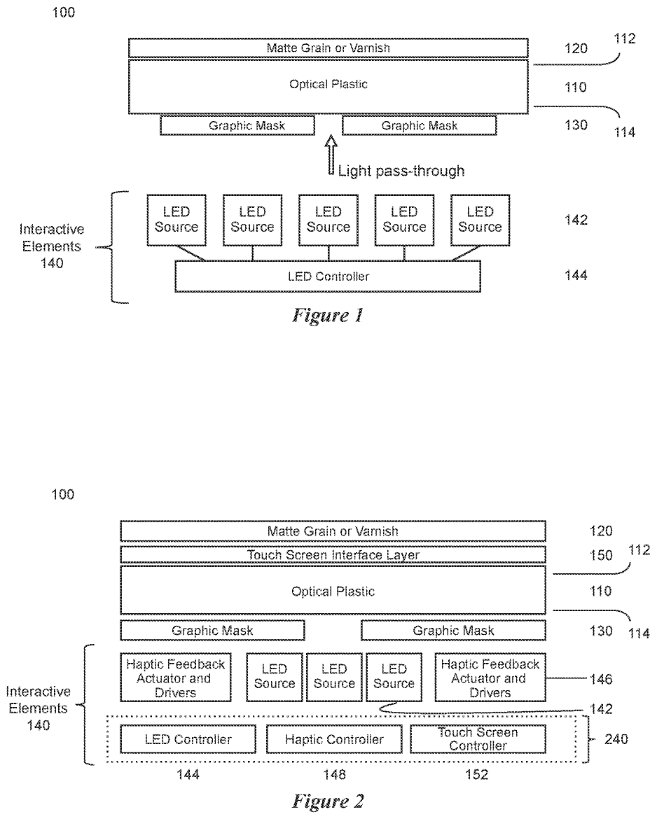

Generally described, in illustrative embodiments, individual multi-layered display elements can include a number of layers that function to cause selective display of images. As shown in FIG. 1, the multi-layered display element 100 may comprise a set of layers 110, 120, 130 and additional elements, as described herein. For purposes of the present application, individual layers of the multi-layered display element 100 may be referred to as first, second, third layers, respectively. Additionally, the layers 110, 120, 130 may also be reference with regard to the materials or properties, such as a plastic layer, matte grain or varnish, graphic mask, etc. Such reference to materials may be considered to be illustrative in nature and should not be construed as limiting. Additionally, reference to alternatives or implementations with regard to materials or properties (e.g., plastic, matte grain or varnish, graphic mask, etc.) should be interpreted as applying generally to a respective layer (e.g., first, second, third layers) and not requiring the specific materials in all embodiments.

Illustratively, the multi-layered display element 100 can include a first layer 110 that corresponds to an optical plastic. The multi-layered display element 100 can include a second layer 120 that corresponds to a matte grain or varnish. The multi-layered display element 100 can further include a third layer 130 that corresponds to a graphic mask. The second and third layers, 120, 130, respectively corresponding to matte grain or varnish and the graphic mask, are arranged on opposite surfaces of the first layer 110 corresponding to the optical plastic. In some embodiments, the multi-layered display element 100 also comprises one or more interactive elements 140. In some embodiments, the interactive elements 142 can correspond to a light source (e.g., an LED) that is located behind the first layer (e.g., optical plastic 110), as illustrated in FIG. 1. The interactive elements 140 can include separate controllers 144 for the LED sources 142. LED sources 142 may be each controlled and/or tuned individually to emit light having a different spectrum. For example, interactive elements 140 according to the present invention may enable the light sources to be individually dimmed or boosted. LED sources 142 may be independently configured to generate selective light. In some embodiments, LED sources 142 may be individually controlled by location, color, or temperature. LED sources 142 may be individually connected to the controller 144. LED sources 142 may be individually tuned in order to produce a well-defined light flux or spectrum, as such, resulting to be able to create a gradient of light. Although the lighting device has been described taking FIG. 1 as an example, it is to be noted that a person ordinarily skilled in the art should appreciate that the present disclosure is not limited thereto.

In some embodiments, the first layer 110 corresponding to the plastic may be composed of an optical-grade resin. In some embodiments, the first layer 110 includes a front or outer surface 112 that is a matte, textured surface. In some embodiments, the plastic may be coated with a matte clearcoat varnish, Illustratively, the varnish may be applied to the plastic after the plastic is molded. In some embodiments, the plastic may have a grained matte finish. The first layer 110 (e.g., plastic) may be formed or molded by any method known in the art, such as, for example, injection molding or thermoforming, but is not limited thereto. In some embodiments, the plastic can be part of a larger display screen, such as a display screen incorporated in. In some embodiments, multiple light sources may be implemented and aligned along the display screen to minimize light attenuation.

In some embodiments, the multi-layered display element 100 may include at least one layer, the third layer 130 that corresponds to a mask. The third layer 130 mask illustratively provides and is responsible for the desired pattern of illumination of the system. In some embodiments, the mask corresponds to a stencil that has translucent and non-translucent areas, so that only a specific pattern is illuminated once light from the light source (e.g., from interactive elements 140) is applied, or otherwise directed to, the mask. The pattern may be printed or lasered onto the mask, wherein any printing technique may be used to prepare the desired pattern on the mask.

In the automotive industry, it is common practice to refer to the multi-layered display element 100 as having various surfaces referred to as A-, B-, or C-surfaces. As used herein, the term “A-surface” refers to an outwardly-facing surface for display in the interior of a motor vehicle, or outer surface of a system or plastic. As illustrated in FIG. 1, the A surface can correspond to an outer surface 112 of the second layer 110. The A-surface is a very high visibility surface of the vehicle that is most important to the observer or that is most obvious to the direct line of vision. As used herein, the term “B-surface” refers to an inwardly-facing surface, or inner surface of a system or plastic. As illustrated in FIG. 1, the B surface can correspond to the inner surface 114 of the second layer 110. The B-surface is not a visible surface of a vehicle or in the direct line of vision. In some embodiments, the B-surface of the plastic may be masked with a light-blocking paint that is laser-etched in the negative shape of the graphic. In some embodiments, the B-surface of the plastic may be masked with an opaque plastic over-mold in the negative shape of the graphic, Some embodiments of the present disclosure relate to a method for masking or etching such plastics. In some embodiments of the method described herein, the B-surface of the plastic (e.g., layer 110) can be masked by a light-blocking paint (e.g., spray/low coat) and laser-ablated/etched in the negative shape of the graphic. In some embodiments of the method described herein, the B-surface of the plastic can be masked by in-mold lamination of printed films (e.g., In-Mold Decoration (IMD)). In other embodiments of the method described herein, the B-surface of the plastic can be masked through roll-to-roll direct ink deposition. In yet another embodiment of the method described herein, the B-surface of the plastic can be masked by an inkjet. In further embodiments of the method described herein, the inkjet may deposit inks with varying degrees of transmission. In some embodiments of the method described herein, the B-surface of the plastic can be masked utilizing optical techniques, for example, through the use of lithography and prisms. In some embodiments of the method described herein, the B-surface of the plastic can be masked by a photoresist mask and UV irradiation, to produce a high-resolution pattern. In other embodiments of the method described herein, the B-surface of the plastic can be masked by prisms on the B-surface of the plastic, which control the path of the light source. In some embodiments of the method described herein, the B-surface of the plastic can be masked by applying a secondary, opaque, plastic over-mold in the negative shape of the graphic on the B-surface of the plastic.

In some embodiments, the multi-layered display element 100 can include an interactive element 140 that includes functionality for receiving touch and/or gesture events inputs and/or providing tactile feedback outputs. In some embodiments, the multi-layered display element 100 further includes a control element 240 for controlling the operation of at least one function of at least one interactive elements 140, comprising at least one or more such interactive elements. Interactive elements may be, for example, capacitive, infrared (IR), touch, force or pressure sensors, but is not limited thereto. For example, as shown in FIG. 2, the multi-layered display element 100 may also comprise of a fourth layer 150 corresponding to a touch screen interface. The touch screen interface layer 150 can illustratively include a number of capacitive elements that generate electrical signals based on compression forces applied to the layer 150. For example, the compression forces may correspond to a finger or instrument applied to the outer surface 112 of the first layer 110 that is applied to the touch interface layer 150. Touch screen controller 152 is an interactive element which can be configured to control the electrical signals generated from the touch interface layer 150.

In this embodiment, the interactive elements 140 can also include one or more haptic feedback devices 146. Individual haptic feedback devices 146 can include a haptic actuator and drivers, which provide haptic feedback to the user in the form of vibrations. The haptic feedback can be individually controlled by at least one of the interactive elements 140. For example, haptic controller 148 can be configured to individually control the haptic feedback. The haptic feedback can correspond to vibration forces applied to the other layers 110, 120, 130, 140 that may be felt by a user or detected by an instrument. The interactive elements 140 can include separate controllers 144, 148, and 152 for the LED sources 142, haptic device 146, and touch screen interface 150.

In further embodiments, the multi-layered display element 100 can include one or more processors for utilization in the control elements. It should be understood that the actuator, driver, processor, and controller may include one or more physical actuators, drivers, processors, controllers. and/or other circuitry to perform the functions described herein. In any of the embodiments disclosed in the present disclosure, the multi-layer display element may include a display panel.

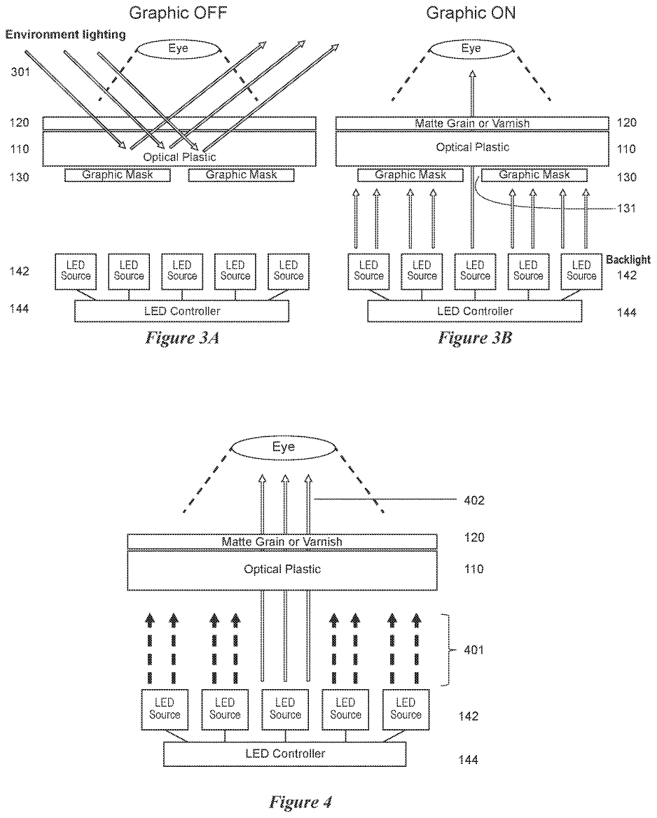

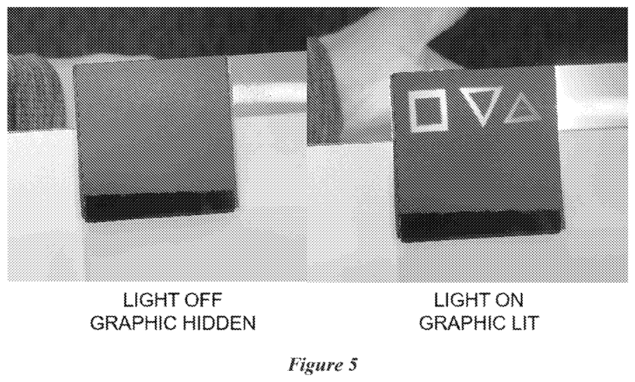

A light source behind the plastic may be switchable between an on state and an off state, hidden until illumination is turned on so that the light produced in the inside the system can be seen from outside, known as Hidden Till Lit (“HTL”). Thus, for example, any graphic which was hidden may be visible after the light source is turned on. As shown in FIG. 3A, when the light source behind the plastic is in the off state, environmental light 301 reflects off optical plastic 110 and an observer perceives the matte grain or varnish 120 of the plastic. In such a state, graphical display or mask 130 is not visible by an observer and the visible surface appears continuous to the observer. As shown in FIG. 3B, when the light source behind the plastic is in the on state, the light source passes through the negative space of the graphic mask 131, optical plastic 110, and then the matte grain or varnish 120. In such a state, the graphical display or illumination is visible by an observer.

The light source may be any light source that can be used to provide the required amount of light, either light of one color or lights of different color. At least one light source may be used, and two or more light sources may also be used. For example, if two or more light sources are used, each light source may provide light in a different color or in a different brightness. In some embodiments, the light source can be controllable so that the illumination is controlled by display criteria.

In some embodiments, the light source may be a graphic or projector which functions as a mask. As shown in FIG. 4, the light source functions as a mask. The dark or unlit areas 401 may be a result of black pixels on the display and/or wherein individual light sources are in the off state. Conversely, individual light sources in the on state may allow the light source to pass through optical plastic 110 and then the matte grain or varnish 120, providing lit areas 402. Lit areas 402 allow the graphical display or illumination to be visible by an observer. In some embodiments, the light sources may provide an illuminated pattern that can be changeable or programmable. This may allow for colors and animations to be shown that may be, for example, a reflection of the state of the vehicle or similar. FIG. 5 provides an example the matte finished optical plastic with hidden graphics when the light is off and with lit graphics when the light is on.

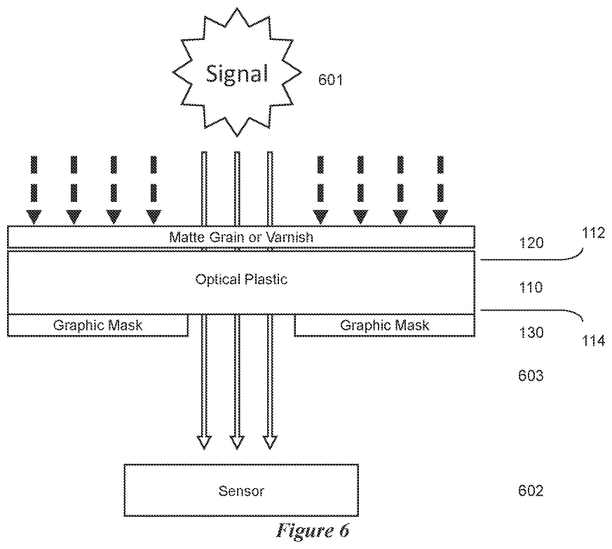

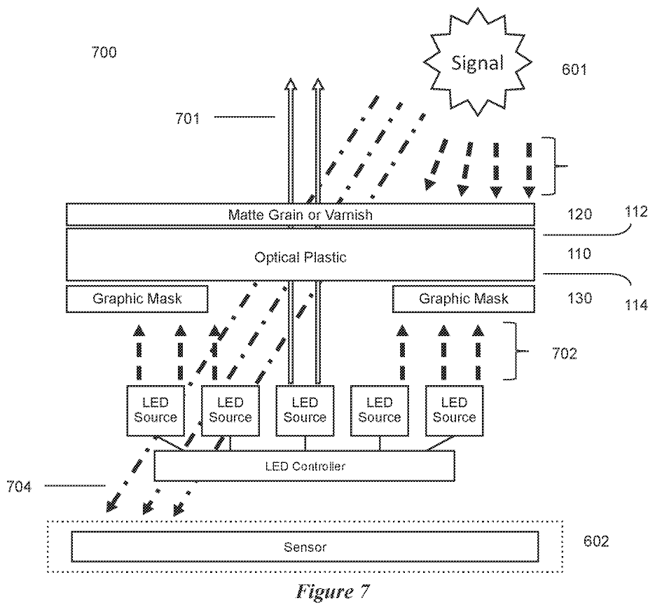

Some embodiments of the present disclosure relate to a masked optical plastic 100 which may allow a signal 601 to pass from the A-surface of the plastic 112 through the B-surface of the plastic 114. In some embodiments, a sensor 602 (i.e., camera or IR sensor) may be disposed behind the plastic. As shown in FIG. 6, a signal may pass through the matte grain or varnish finish of the front surface of the plastic 120. In some embodiments, the signal then may pass through the optical plastic 110. In some embodiments, the signal may pass through the unmasked portions of the plastic 603. In some embodiments, the signal may partially pass through the plastic. In other embodiments, a portion of the signal may pass through the plastic. In some embodiments, the signal is blocked before reaching the sensor. In further embodiments, the signal is partially blocked before reaching the sensor. In yet further embodiments, a portion of the signal is blocked before reaching the sensor.

In some embodiments of the present disclosure, the masked optical plastic 700 may allow a light source to pass from the B-surface of the plastic 114 through the A-surface of the plastic 112, and simultaneously allow a signal 601 to pass from the A-surface of the plastic 112 through the B-surface of the plastic 114, as shown in FIG. 7. In some embodiments, the light source may partially pass through the plastic and/or the signal may partially pass through the plastic. FIG. 7 depicts a masked optical plastic 700 according to one embodiment of the present disclosure. Masked optical plastic 700 allows light source 701 to pass from the B-surface of the plastic 114 through the A-surface of the plastic 112. In addition, masked optical plastic 700 allows signal 703 to pass from the A-surface of the plastic 112 through the B-surface of the plastic 114. Masked portions of the light source 702 are blocked before reaching the observer. Similarly, masked portions of the signal 704 are blocked before reaching the sensor.

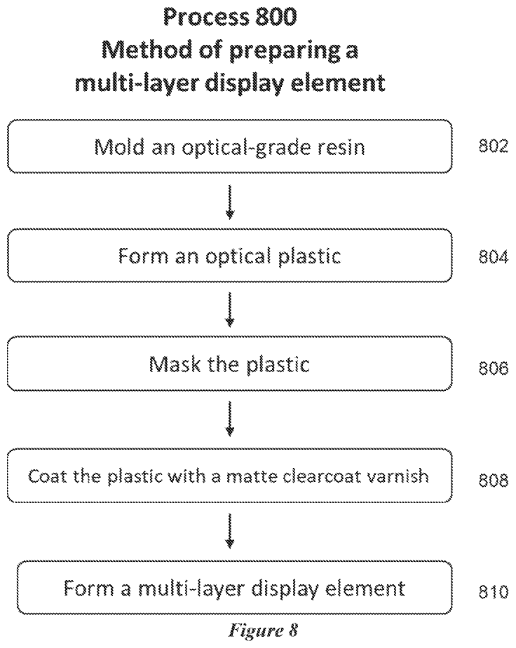

Some embodiments of the present disclosure relate to a method for preparing the multi-layer display element disclosed herein. FIG. 8 is a flowchart of process 800 for preparing a multi-layer display element, according to one embodiment. The method includes molding an optical-grade resin 802 and forming an optical grade plastic 804. Once the optical grade plastic is formed, the plastic is masked 806. The plastic is then coated with a matte clearcoat varnish 808, to form a multi-layer display element 810.

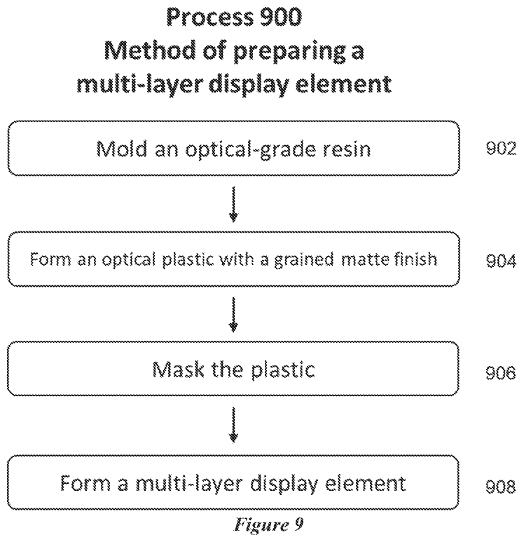

FIG. 9 is also a flowchart of an alternative process 900 for preparing a multi-layer display element, according to one embodiment. The method includes molding an optical-grade resin 902 and forming an optical grade plastic with a grained matte finish 904. The optical grade plastic is then masked 906, to form a multi-layer display element 908.

In some embodiments, a method is provided for producing a multi-layer display element capable of hiding an outline of a graphic comprising: (i) molding an optical-grade resin into a desirable shape, resulting in a plastic; (ii) masking the B-surface of the plastic; and (iii) coating the A-surface of the plastic with a matte clearcoat varnish.

In some embodiments, a method is provided for producing a multi-layer display element capable of hiding an outline of a graphic comprising: (i) molding an optical-grade resin into a desirable shape, resulting in a plastic, wherein the plastic has a grained matte finish out of the mold; and (ii) masking the B-surface of the plastic.

Various embodiments of the present disclosure may be a system, a method, and/or a computer program product at any possible technical detail level of integration, The computer program product may include a computer readable storage medium (or mediums) having computer readable program instructions thereon for causing a processor to carry out aspects of the present disclosure. For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions (also referred to herein as, for example, “code,”instructions,“module,”application,“software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected actions or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a computer (e.g., the executing computing device), partly on a computer, as a stand-alone software package, partly on the a computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that individual blocks of the flowchart illustrations and/or block diagrams related to computing functionality or controllers, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that individual blocks of the block diagrams and/or flowchart illustration, and combinations of blocks in the block diagrams and/or flowchart illustration, related to computing functionality can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments may not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others. Similarly, a system comprising one or more layers should not be interpreted as excluding additional layers or elements in a multi-layered display element.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated the appended claims rather than by the foregoing description. All changes which come within the meaning and range of equivalency of the claims are to be embraced within their scope.

What is claimed is:

1. A multi-layer display element comprising:
a first layer comprising an optical plastic;
a second layer comprising a matte grain or varnish, wherein the second layer is disposed onto the first layer;
a third layer comprising a graphical mask, wherein the third layer is disposed onto the first layer, and wherein the second layer and the third layer are arranged on opposite surfaces of the first layer; and
at least one interactive component configured to provide a light source.

2. The multi-layer display element of claim 1, further comprising a fourth layer comprising a touch screen interface.

3. The multi-layer display element of claim 2, further comprising at least one haptic feedback actuator device.

4. The multi-layer display element of claim 3, wherein the at least one haptic feedback actuator device includes a plurality of haptic feedback actuators.

5. The multi-layer display element of claim 1, wherein the at least one interactive component configured to provide a light source includes a plurality of light sources, wherein the light sources are independently operable to generate selective light or a light flux or spectrum.

6. The multi-layer display element of claim 1, wherein the first layer corresponds to an optical plastic, the second layer corresponds to a matte grain or varnish, and the third layer corresponds to a graphical mask.

7. The multi-layer display element of claim 1, wherein the first layer corresponds to a matte grain or varnish.

8. The multi-layer display element of claim 1, wherein the first layer corresponds to a graphical mask.

9. A multi-layer display element comprising:
an A-surface;
a B-surface; and
at least one interactive component configured to provide a light source,
wherein the A-surface is the outer surface of the multi-layer display element, the B-surface is the inner surface of the multi-layer display element, and wherein the A-surface and the B-surface are on opposite sides of the multi-layer display element,
wherein the A-surface comprises a matte grain or varnish, and
wherein the B-surface is configured to control the path of the light source.

10. The multi-layer display element of claim 9, wherein the B-surface comprises a graphical mask.

11. The multi-layer display element of claim 9, further comprising a touch screen interface.

12. The multi-layer display element of claim 11, further comprising at least one haptic feedback actuator device.

13. The multi-layer display element of claim 12, wherein the at least one haptic feedback actuator device includes a plurality of haptic feedback actuators.

14. The multi-layer display element of claim 9, wherein the at least one interactive component configured to provide a light source includes a plurality of light sources, wherein the light sources are independently operable to generate selective light or a light flux or spectrum,

15. A method of producing a multi-layer display element comprising:
molding an optical-grade resin into a plastic comprising an A-surface and a B-surface; and
masking the B-surface of the plastic.

16. The method of producing a multi-layer display element of claim 15, wherein the plastic has a grained matte finish after being molded.

17. The method of producing a multi-layer display element of claim 15, further comprising coating the A-surface of the plastic with a matte clearcoat varnish.

18. The method of producing a multi-layer display element of claim 17, wherein the masking of the B-surface of the plastic comprises laser-etching a light-blocking paint onto the B-surface of the plastic.

19. The method of producing a multi-layer display element of claim 17, wherein the masking of the B-surface of the plastic comprises over-molding the plastic with an opaque plastic.

20. The method of producing a multi-layer display element of claim 17, wherein the multi-layer display element is capable of hiding an outline of a graphic.

21. The method of producing a multi-layer display element of claim 20, wherein the masking of the B-surface of the plastic is disposed in the negative shape of the graphic.

22. The method of producing a multi-layer display element of claim 17, wherein the multi-layer display element further comprises a display panel.

23. The method of producing a multi-layer display element of claim 17, wherein the multi-layer display element is capable of allowing a light source to pass from the B-surface of the plastic through the A-surface of the plastic.

24. The method of producing a multi-layer display element of claim 17, wherein the multi-layer display element is capable of allowing a signal to pass from the A-surface of the plastic through the B-surface of the plastic.
